(19) United States
(12) Patent Application Publication
(10) Pub. No.: US 2021/0071276 A1
(43) Pub. Date: Mar. 11, 2021

(54) METHOD FOR QUENCH SEASONING OF IRON/STEEL COOKWARE

(71) Applicant: HENRY JOHNSON PTY LTD AS TRUSTEE FOR THE HENRY JOHNSON FAMILY TRUST, Kenmore Hills (AU)

(72) Inventor: MARK JAMES HENRY, Kenmore Hills (AU)

(21) Appl. No.: 17/015,353

(22) Filed: Sep. 9, 2020

Related U.S. Application Data
(60) Provisional application No. 62/898,642, filed on Sep. 11, 2019.

(51) Int. Cl. C21D 9/00; C21D 7/06; C21D 1/63; C21D 1/18

(52) U.S. Cl. CPC C21D 9/0068; C21D 1/18; C21D 1/63; C21D 7/06

(57) ABSTRACT

The method for quench seasoning multiple units of iron/steel cookware includes the steps of: preheating each cookware unit to a temperature above the smoke point of oil in an oil bath; rapidly plunging the preheated cookware units into the oil bath to completely submerge the cookware units and quickly enough to ensure the temperature of the cookware units remain above oil smoke point; controlling the temperature of the oil bath to a ensure that the temperature of the oil bath does not reach a temperature close to oil smoke point, for example, a temperature within 20 degrees below smoke point, and retrieving the cookware units from the oil bath.

### BACKGROUND OF THE INVENTION

### 1. Field of the Invention

The present invention relates to cookware and more particularly to a method for quench seasoning of iron/steel cookware.

### 2. Description of Prior Art Including Information Disclosed under 37 CFR 1.97 and 1.98

Bare iron and steel rusts quickly when exposed to the elements. For as long as iron or steel cookware has existed (2,000+ years), so has the need to protect that bare metal cookware from corrosion. Iron age cooks would have quickly discovered that cooking with fats left a hard, black coating on the iron, which created a barrier and sealed the metal from attack by oxygen and other corrosive elements. The coating was simply fats transformed by heat into the hard, inert product that is commonly referred to as ‘seasoning’. Over time, it was found that this natural coating also helped reduce sticking of food to the iron cookware surface.

The recent resurgence of cooking in cast iron, wrought iron, and steel, for health reasons has led to an increased interest in the old methods of seasoning cookware in the restaurant and home. Many iron/steel cookware manufacturers still sell their cookware in the ‘raw’ form, protected from rust with some form of coating, which the consumer must remove before starting their own seasoning and cooking. This can be a burden for consumers who may not have the necessary experience, and a barrier that encourages them to seek again the convenience of synthetic-coated cookware.

In recent decades, some cookware manufacturers have used production seasoning techniques to create a reasonable ‘pre-seasoned’ coating on new iron/steel cookware, and this has proven popular with consumers. The benefits are that the cookware does not rust before consumers receive it, and the seasoning can be a good start for the consumer to build additional seasoning, to further improve corrosion resistance and reduce sticking during cooking.

Despite the high energy costs to heat the cookware in production, it is still more efficient than each consumer replicating the process in their home ovens. The most common method in production is to hang the cookware (cold or pre-warmed), usually on a conveyor or rack system for efficiency, spray the cookware with a suitable oil or oil mixture, then heat the cookware in an oven above the smoke point of the oil (typically 200 C-350 C, depending on the oil), then cooled to transform it into the desirable hard seasoned coating.

Disadvantages of the conventional production seasoning method described above include:

High cost of automation to reduce seasoning costs/unit to viable levels for consumers.

Significant smoke generated by heating the oil above its smoke point over a large surface area in contact with the air.

Inconsistency of surface finish caused by the oil running when heat renders it more viscous, then solidifies it into unattractive, and potentially sticky, thicker spots and streaks.

Slow heating and cooling of the cookware up to smoke point, then back down to room temperature.

### BRIEF SUMMARY OF THE INVENTION

It is well known in the heat treatment of metals that plunging a hot metal component into an oil bath to rapidly ‘quench’ it not only can transform the metal's mechanical properties, but can also leave a film of hard oil on the metal component. However, for most quenching treatments, the temperature is far too high for the oil to survive, and an unattractive carbonized scale is all that remains on the surface.

The present invention uses the principle of quenching metal in oil, but at a lower temperature than most traditional heat treatment quenching. The cookware unit such as a pan is pre-heated to the correct temperature for transforming the oil (above smoke point, but below disintegration point), then the cookware is plunged into a bath or vessel containing the suitable oil. The rapid cooling of the pan on contact with the oil ensures that the oil is quickly transformed into the hard, seasoned product when the hot pan is very rapidly cooled below the smoke point.

For a visually consistent finish all over the cookware, and to avoid patchy thin or thick areas, it is essential for the whole pan to be submerged in the oil before any part of the pan can cool below the smoke point.

Manual methods of heating and plunging are quite simple (home oven and drum of oil, for example), but lack the productivity to be viable during the volume production of cookware. High cookware handling temperatures, splashes, and smoke emissions could also be hazardous for a human operator.

### BRIEF DESCRIPTION OF THE SEVERAL VIEWS OF DRAWINGS

The present invention relates to a method for quench seasoning of iron/steel cookware as described in detail in the following specification and recited in the annexed claims, taken together with the accompanying drawings in which:

FIG. 1 is an illustration of an example of the equipment which could be used to perform the method of the present invention; and

FIG. 2 is a flow chart of the steps of the method.

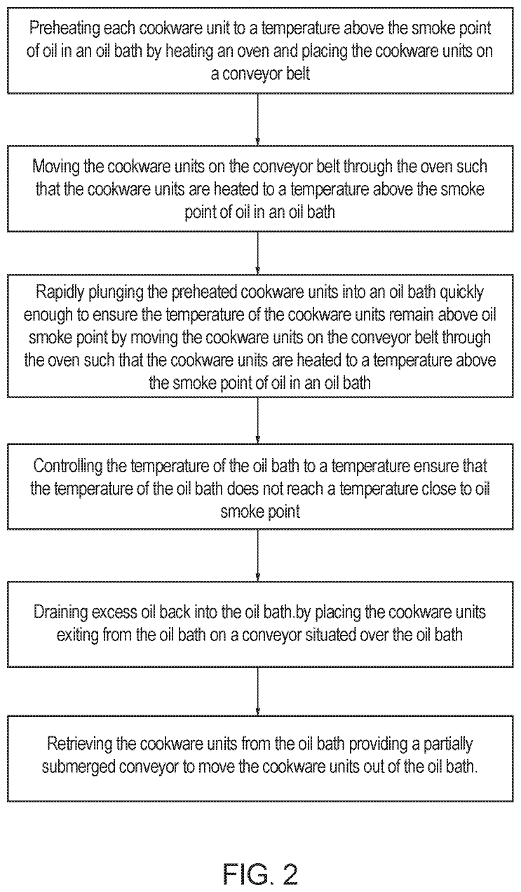

### DETAILED DESCRIPTION OF THE INVENTION

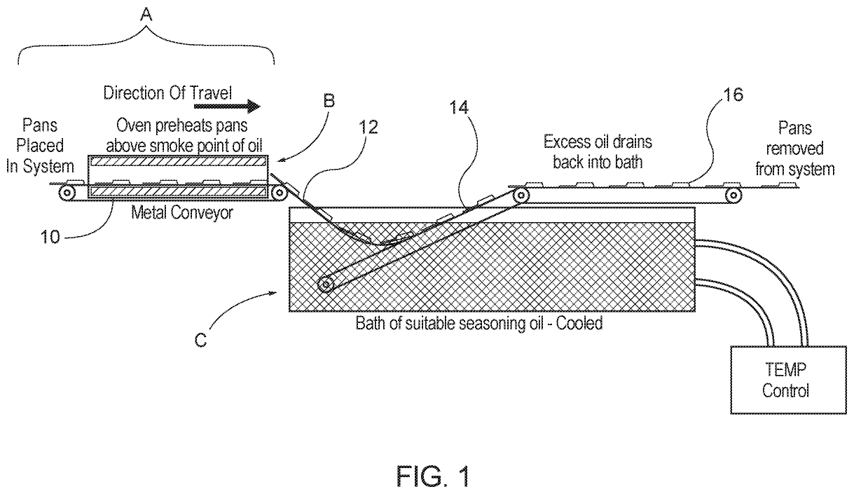

The present invention provides a method of quench seasoning iron/steel cookware such as pans suitable for commercial production which employs automation with minimal human contact. The method may be performed using the equipment shown in FIG. 1, including:

An automated conveyor system, generally designated A, for moving the cookware units. The conveyor system A, for example, could be an overhead conveyor track with hooks, or surface conveyors such as rolling metal mesh belt 10.

A suitable oven, generally designated B, including an open-ended heat chamber for conveyor A to pass the cookware units through for a sufficient time to preheat the cookware units to a temperature above the smoke point of oil, but below the disintegration point.

A container, generally designated C, for oil bath, which allows the cookware units to be rapidly plunged into the oil bath to be entirely submerged and fast enough to ensure the temperature of the cookware units remain above the oil smoke point, while minimizing splash and smoke generated. This causes the cookware to be quickly transformed into the hard, seasoned product when the hot cookware unit is very rapidly cooled below the smoke point.

The cookware unit is preheated to a temperature higher enough to fully transform the oil into a gray/black hard polymerized seasoning but low enough to avoid the seasoning being burned and flake off the cookware by the excessive heat. Plunging could be simply a drop into the oil bath, or more controlled short steep chute 12 which delivers the cookware units to the oil bath in the correct orientation and a second conveyor 14 which moves the cookware units from chute 12 through the oil bath.

Preferably, a temperature control system, general designated D, which acts as a means of continuously cooling the oil bath to ensure that the oil bath doesn't reach a temperature too close to the oil smoke point, for example, within 20 degrees below smoke point, to avoid excessive emissions, or danger of ‘flash’ fire.

Preferably, an automated method of retrieving the cookware units from the oil bath, such as partially submerged conveyor 14 or hook system to transport the cookware units to a draining area which preferably recycles the remaining wet oil back into the bath, such as a third conveyor 16.

In trials, improved results were found when the cookware was grit blasted/peened before entering the quench seasoning process. The added texture helped the oil grip to the surface of the iron/steel better than a smooth wrought, polished, or machined surface finish.

Instead of conveyors, a racking system could be used to transport cookware units into and out of oven, then into oil bath, although plunging multiple cookware units simultaneously into the oil bath would be problematic (speed of plunge and heating of the oil bath) and throughput would be limited by the volume of oil required around each cookware unit to avoid these undesirable effects.

An overhead conveyor and hook system could be used throughout, although the plunge into the oil bath would need to be more rapid than most conveyor systems would allow.

A tilting oven, which discharges all the cookware units into an oil bath when tilted after heating could be used. However, practical problems in using such an oven include too little oil volume around each pan for correct cooling, and impact damage from colliding pans.

Different types of oil have different smoke points and therefore will necessitate a different temperature for the cookware units immediately before the plunge in the oil (the ‘quench’). One example is rice bran oil, which typically requires a temperature of 450 C-480 C (depending on the exact rice bran oil used). Any lower, and the oil may not fully transform into a gray/black hard polymerized seasoning. Any higher, and the seasoning may be burned and flaked off the pan by the excessive heat. Several trials at different temperatures may be necessary to arrive at the optimal temperature for each particular oil.

Quench time should be the same for all oils: rapid enough to avoid the cookware units dropping below the optimal temperature range for the oil, as described above, before it plunges into contact with the oil. A very slow plunge would cool the cookware units below the transformation temperature of the oil ahead of its contact with the oil, resulting in lighter coloring and sticky semi-transformed oil.

In practice, the whole cookware unit should be fully immersed in the oil bath within one second, for most common thicknesses of iron or steel cookware. A thicker cookware unit can be plunged slightly more slowly, due to greater internal heat retention, while a thinner pan would need a faster plunge to avoid losing temperature too quickly.

Further, it is advantageous to add texture to the surface of the cookware units prior to preheating the cookware units. This can be achieved by grit blasting or by peening, which is the process of working a metal's surface to improve its material properties, usually by mechanical means, such as hammer blows, by blasting with shot or blasts of light beams.

Accordingly, the present invention is a method for quench seasoning multiple units of iron/steel cookware comprising the steps of:

preheating each cookware unit to a temperature above the smoke point of oil in an oil bath;

rapidly plunging the preheated cookware units into an oil bath quickly enough to ensure the temperature of the cookware units remain above oil smoke point;

controlling the temperature of the oil bath to a temperature ensure that the temperature of the oil bath does not reach a temperature too close to oil smoke point; and

retrieving the cookware units from the oil bath.

The step of preheating the cookware units includes the steps of:

heating an oven;

placing the cookware units on a conveyor belt; and

moving the cookware units on the conveyor belt through the oven such that the cookware units are heated to a temperature above the smoke point of oil in an oil bath.

The step of preheating the cookware comprises preheating the cookware unit to a temperature higher enough to fully transform the oil into a gray/black hard polymerized seasoning but low enough to avoid the seasoning being burned and flake off the cookware by the excessive heat.

The step of rapidly plunging the preheated cookware units into an oil bath includes providing a chute extending from the oven to the oil bath such that the cookware units move from the oven to the oil bath and are fully submerged in the oil bath.

The method further includes the step of draining excess oil back into the oil bath by placing the cookware units exiting from the oil bath on a conveyor situated over the oil bath.

The step of retrieving the cookware units from the oil bath includes providing a partially submerged conveyor to move the cookware units out of the oil bath.

The step of controlling the temperature of the oil bath includes the step of cooling the oil in the oil bath to ensure that the oil bath doesn't reach a temperature within 20 degrees below smoke point. Preferably, the temperature is controlled by continuously cooling the oil in the oil bath.

The method further includes the step of adding texture to the surface of the cookware units prior to preheating the cookware units, for example by grit blasting or peening.

Following are the advantages of the quench method of seasoning of the present invention over the conventional industrial ‘hang, spray, heat’ methods:

The ability to fully automate the process and exclude humans from the inherent hazards.

Lower costs per unit for seasoning when rate of plunging of cookware units is maximized by a large, cooled, oil tank and an oven matched to this rate.

Reduced smoke emissions.

More visually consistent results from the rapid, almost instantaneous, transformation of the oil to seasoning, evenly all over every surface the cookware unit (due to the temperature and cooling rate being the same all over).

Potentially harder and more durable seasoning coatings due to the higher temperatures (with higher smoke point oils), and faster cooling rates from quenching, than common ‘hang, spray, heat’ production seasoning methods.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims:

I claim:

1. A method for quench seasoning multiple units of iron/steel cookware comprising the steps of:
preheating each cookware unit to a temperature above the smoke point of oil in an oil bath;
rapidly plunging the preheated cookware units into an oil bath to completely submerge the units and quickly enough to ensure the temperature of the cookware units remain above oil smoke point;
controlling the temperature of the oil bath to a ensure that the temperature of the oil bath does not reach a temperature too close to oil smoke point; and
retrieving the cookware units from the oil bath.

2. The method of claim 1 wherein the step of preheating the cookware units comprises the steps of:
heating an oven;
placing the cookware units on a conveyor belt; and
moving the cookware units on the conveyor belt through the oven such that the cookware units are heated to a temperature above the smoke point of oil in an oil bath.

3. The method of claim 2 wherein the step of rapidly plunging the preheated cookware units into an oil bath comprises providing a chute extending from the oven to the oil bath such that the cookware units move from the oven to the oil bath.

4. The method of claim 1 further comprising the step of draining excess oil back into the oil after the cookware units are removed from the oil bath.

5. The method of claim 1 further comprising the step of draining excess oil by placing the cookware units exiting from the oil bath on a conveyor situated over the oil bath.

6. The method of claim 1 wherein the step of retrieving the cookware units from the oil bath comprises providing a partially submerged conveyor to move the cookware units out of the oil bath.

7. The method of claim 1 wherein the step of controlling the temperature of the oil bath comprises the step of cooling the oil in the oil bath to a temperature to ensure that the oil bath doesn't reach a temperature within 20 degrees below smoke point.

8. The method of claim 1 wherein the step of controlling the temperature of the oil bath comprises the step of continuously cooling the oil in the oil bath.

9. The method of claim 1 further comprising the step of adding texture to the surface of the cookware units prior to preheating the cookware units.

10. The method of claim 9 wherein the step of adding texture comprises grit blasting or peening.

11. The method of claim 1 wherein the cookware unit is preheated to a temperature higher enough to fully transform the oil into a gray/black hard polymerized seasoning but low enough to avoid the seasoning being burned and flake off the cookware by the excessive heat.
